(19) United States
(12) Patent Application Publication
(10) Pub. No.: US 2007/0015884 A1
(43) Pub. Date: Jan. 18, 2007

(54) Epoxy resin additives and epoxy resin compositions

(75) Inventors: Akira Yamamoto, Annaka-shi (JP); Shoji Ichinohe, Annaka-shi (JP); Eiichi Tabei, Annaka-shi (JP)

Correspondence Address: BIRCH STEWART KOLASCH & BIRCH, PO BOX 747, FALLS CHURCH, VA, 22040-0747, US

(73) Assignee: Shin-Etsu Chemical Co., Ltd.

(21) Appl. No.: 11/483,587

(22) Filed: Jul. 11, 2006

(30) Foreign Application Priority Data
Jul. 12, 2005 (JP) 2005-202519

(51) Int. Cl. C08L 63/00; C08L 83/00; C08G 77/04; B32B 27/38

(52) U.S. Cl. 525/476; 525/524; 528/25; 528/421

(57) ABSTRACT

Epoxy-modified low molecular weight silicones are added to epoxy resins for reducing surface tension and improving fluidity.

### CROSS-REFERENCE TO RELATED APPLICATION

This non-provisional application claims priority under 35 U.S.C. §119(a) on Patent Application No. 2005-202519 filed in Japan on Jul. 12, 2005, the entire contents of which are hereby incorporated by reference.

### TECHNICAL FIELD

This invention relates to epoxy resin additives which are added to epoxy resins for reducing surface tension and improving fluidity, and epoxy resin compositions comprising the additives.

### BACKGROUND ART

A wide variety of materials have recently been developed and proposed in the field of electric and electronic applications. While components with a profile for efficient streamlining of the manufacturing process are desired, materials are required to have better fluidity and impregnation.

In the prior art, modified silicones are added to epoxy resins, typically epoxy molding compounds (EMC) for imparting flexibility. The groups used for modification include amino, epoxy, carboxyl, phenolic hydroxyl and polyether groups. The modified silicones generally have a chain length of at least 20 silicon atoms because they are added for the purpose of imparting flexibility. Low molecular weight modified silicones having a chain length of 2 to 4 silicon atoms are not used. See JP-A 04-41520, JP-A 06-145299, and JP-A 2001-11288.

So far low molecular weight modified silicones are known and are used as contact lens-forming raw materials and monomers for cationic polymerization. It is unknown in the art to use silicones of 2 to 4 monomeric units as an epoxy resin additive.

Prior Art 1: JP-A 04-41520

Prior Art 2: JP-A 06-145299

Prior Art 3: JP-A 2001-11288

### DISCLOSURE OF THE INVENTION

An object of the present invention is to provide epoxy resin additives which are added to epoxy resins for reducing the surface tension thereof and improving the fluidity thereof, and thus useful as leveling agents and fluidizing agents for epoxy resins; and epoxy resin compositions having the same added.

The inventor has found that the addition of an epoxy-modified low molecular weight silicone having a chain length of 2 to 4 silicon atoms to an epoxy resin reduces the surface tension thereof and improves the fluidity thereof.

The present invention provides an epoxy resin additive comprising an epoxy-modified low molecular weight silicone having the general formula (I). 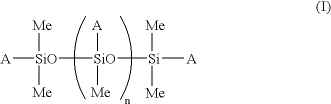
Herein Me is methyl, A is each independently a group selected from R¹, R², and Me, wherein R¹ and R² are groups of the following structures: 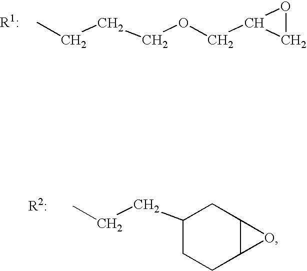
only one independent A is R¹ or R², and the remaining groups A are Me, and n is an integer of 0 to 2.

In a preferred embodiment, the epoxy-modified low molecular weight silicone has the general formula (II). 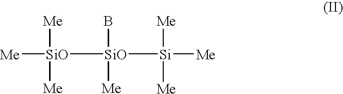
Herein Me is methyl, and B is R¹ or R², wherein R¹ and R² are as defined above.

Also contemplated herein is an epoxy resin composition comprising 100 parts by weight of an epoxy resin and 0.1 to 10 parts by weight of the additive.

### BENEFITS OF THE INVENTION

The additives of the invention, when added to epoxy resins, can reduce the surface tension and improve the fluidity of the epoxy resins.

### DESCRIPTION OF THE PREFERRED EMBODIMENTS

The epoxy resin additive of the invention is an epoxy-modified low molecular weight silicone containing only one epoxy group in the molecule and having a structure of the general formula (I). 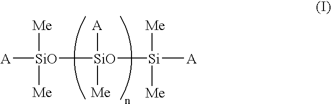
Herein Me is methyl. A is each independently a group selected from R¹, R², and Me. R¹ and R² are groups of the following structures. 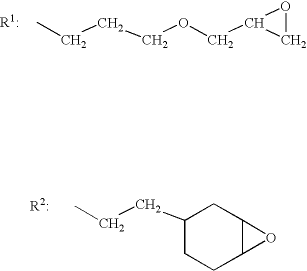
Only one independent A is R¹ or R², and the remaining groups A are Me. The subscript n is an integer of 0 to 2.

In formula (I), n is an integer of 0, 1 or 2. If n has a value of more than 2, the silicone becomes less compatible with epoxy resins and less effective for reducing surface tension.

The objects of the invention is achieved more effectively with an epoxy-modified low molecular weight silicone of a structure having the general formula (II). 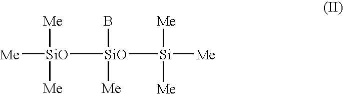
Herein Me is methyl, and B is R¹ or R², wherein R¹ and R² are as defined above.

Any method may be used for the synthesis of the epoxy-modified low molecular weight silicones. In general, they are synthesized by addition reaction of a corresponding hydrogendimethylpolysiloxane with allyl glycidyl ether or vinylcyclohexene oxide in the presence or absence of a solvent and in the presence of a platinum catalyst derived from chloroplatinic acid.

In one preferred reaction procedure, a reactor is charged with hydrogendimethylpolysiloxane, and allyl glycidyl ether or vinylcyclohexene oxide is added dropwise thereto together with the catalyst. In another preferred reaction procedure, a reactor is charged with allyl glycidyl ether or vinylcyclohexene oxide and the catalyst, and hydrogendimethylpolysiloxane is added dropwise thereto. The reaction is preferably carried out in a nitrogen stream in order to suppress oxidation of epoxy groups. During the dropwise addition, the temperature is preferably at or below 100° C. After the completion of dropwise addition, the internal temperature is raised to 120° C. at maximum, at which the reaction mixture is aged to drive the reaction to completion.

The epoxy-modified low molecular weight silicones, when added to epoxy resins, can reduce the surface tension and improve the fluidity of the epoxy resins. Specifically, the additives reduce the surface tension to a value of at most 0.9 fold, especially 0.5 to 0.9 fold of the surface tension of neat epoxy resin and improve the fluidity to a value of at least 1.2 folds, especially 1.2 to 2.0 folds of the fluidity of neat epoxy resin.

Examples of the epoxy resins to which the epoxy-modified low molecular weight silicones are added include, but are not limited to, aromatic epoxy resins such as bisphenol A type, bisphenol F type, novolac and brominated epoxy resins; and aliphatic epoxy resins such as cycloaliphatic, glycidyl ester, glycidyl amine, and heterocyclic epoxy resins. Other epoxy resins are also included.

Preferably the epoxy-modified low molecular weight silicone is added to an epoxy resin in an amount of 0.1 to 10 parts by weight per 100 parts by weight of the epoxy resin. In a more preferred embodiment, the addition amount is 0.5 to 5 parts by weight. Addition amounts below the range may fail to achieve the desired surface tension reducing and fluidity improving effects while excessive amounts are uneconomical.

The invention also provides an epoxy resin composition comprising an epoxy resin and the epoxy-modified low molecular weight silicone described above. The composition may further comprise optional components as will be described below.

In one embodiment, a curing agent for curing epoxy resin may be added to the epoxy resin composition. The curing agent used herein is not particularly limited as long as it can cure the epoxy resin. Any curing agents well known for use in conventional curable epoxy resin compositions are useful. For example, compounds having at least two functional groups capable of reacting with epoxy groups in the epoxy resins are useful while their molecular structure and molecular weight are not particularly limited. Exemplary functional groups are phenolic hydroxyl groups, amino groups, acid anhydride groups and the like, with the proviso that in the case of acid anhydride group, inclusion of at least one such group is sufficient.

The curing agent is compounded in a sufficient amount to cure the epoxy resin, which varies over a wide range. For example, when a phenolic curing agent is used, it is desirably compounded in such an amount that 0.8 to 1.4 moles, especially 0.9 to 1.2 moles of phenolic hydroxyl groups are available per mole of epoxy groups in the epoxy resin.

In the epoxy resin composition of the invention, there may also be compounded cure accelerators for accelerating the cure reaction of the epoxy resin with the curing agent, various inorganic fillers such as fused silica, crystalline silica, alumina, boron nitride, aluminum nitride, silicon nitride, magnesia, magnesium silicate, and aluminum, and other additives commonly used in epoxy resin compositions.

The epoxy resin composition is obtained by mixing the above-described components by a standard technique. Due to the presence of the epoxy-modified low molecular weight silicone, the epoxy resin composition thus obtained has a low surface tension and a good fluidity. For example, when the epoxy resin composition is applied to glass cloth epoxy resin copper-clad laminates, the resin impregnation is enhanced, leading to improved productivity.

### EXAMPLE

Examples of the invention are given below by way of illustration and not by way of limitation.

### Examples 1-8 and Comparative Examples 1-6

To 100 parts by weight of bisphenol F epoxy resin YDF-8170 (Tohto Kasei Co., Ltd.) as an aromatic epoxy resin or Epikote YX8000 (Japan Epoxy Resin Co., Ltd.) as a cycloaliphatic epoxy resin, compound α, β or γ of the formulae shown below was added in the amount (pbw) shown in Tables 1 and 2. It is noted that compound γ is outside the scope of the invention.

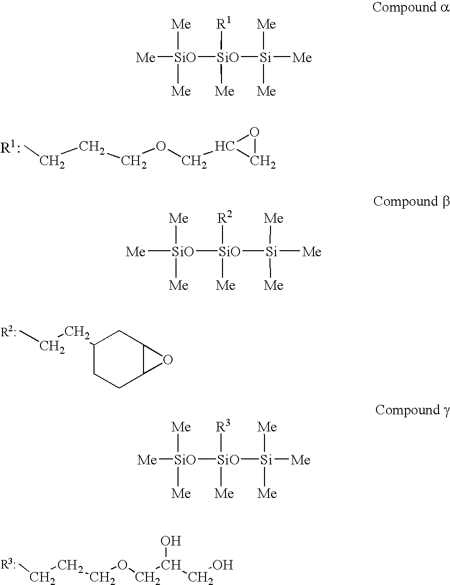

The resulting compositions were examined for surface tension and fluidity. The surface tension was measured at 25° C. by the platinum plate method using an automatic surface tension meter CBVP-Z (Kyowa Interface Science Co., Ltd.). The fluidity was examined by dropping 0.1 g of each epoxy resin composition on a slide glass, allowing the resin to spread, and measuring the diameter of spread resin after 3 minutes.

TABLE 1

| Amount | Comparative | | | Comparative | | | Comparative |
|---|---|---|---|---|---|---|---|
| (pbw) | Example 1 | Example 1 | Example 2 | Example 2 | Example 3 | Example 4 | Example 3 |
| YDF-8170 | 100 | 100 | 100 | 100 | 100 | 100 | 100 |
| Compound α | | 2 | | | 5 | | |
| Compound β | | | 2 | | | 5 | |
| Compound γ | | | | 2 | | | 5 |
| Test results | | | | | | | |
| Surface tension | 49.4 | 27.9 | 24.6 | 26.0 | 23.2 | 22.9 | 23.0 |
| (dyne/cm) | | | | | | | |
| Fluidity (mm) | 9.5 | 12.0 | 16.0 | 10.0 | 14.0 | 17.0 | 12.0 |

TABLE 2

| Amount | Comparative | | | Comparative | | | Comparative |
|---|---|---|---|---|---|---|---|
| (pbw) | Example 4 | Example 5 | Example 6 | Example 5 | Example 7 | Example 8 | Example 6 |
| YX8000 | 100 | 100 | 100 | 100 | 100 | 100 | 100 |
| Compound α | | 2 | | | 5 | | |
| Compound β | | | 2 | | | 5 | |
| Compound γ | | | | 2 | | | 5 |
| Test results | | | | | | | |
| Surface tension | 40.7 | 35.1 | 23.4 | 26.9 | 29.5 | 22.6 | 25.6 |
| (dyne/cm) | | | | | | | |
| Fluidity (mm) | 13.0 | 17.5 | 16.0 | 13.0 | 19.0 | 18.0 | 15.0 |

It is seen from the data of Tables 1 and 2 that the epoxy resins to which the epoxy-modified low molecular weight silicones have been added are reduced in surface tension and improved in flow. The epoxy resins having added thereto compound γ as comparative example are reduced in surface tension, but not improved in flow. The benefits of the invention are demonstrated.

Japanese Patent Application No. 2005-202519 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. An epoxy resin additive comprising an epoxy-modified low molecular weight silicone having the general formula (I): 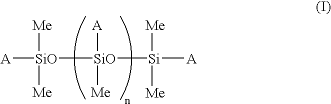
wherein Me is methyl, A is each independently a group selected from R¹, R², and Me, wherein R¹ and R² are groups of the following structures: 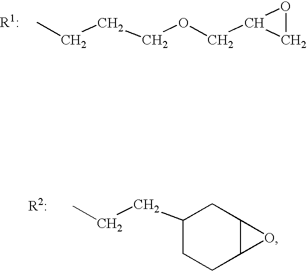
only one independent A is R¹ or R², and the remaining groups A are Me, and n is an integer of 0 to 2.

2. The additive of claim 1 wherein the epoxy-modified low molecular weight silicone has the general formula (II): 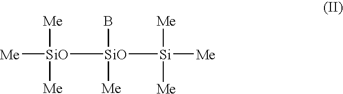
wherein Me is methyl, and B is R¹ or R², wherein R¹ and R² are groups of the following structures.

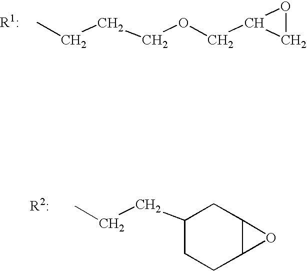

3. An epoxy resin composition comprising 100 parts by weight of an epoxy resin and 0.1 to 10 parts by weight of the additive of claim 1.
